(19) United States
(12) Patent Application Publication
(10) Pub. No.: US 2011/0188454 A1
(43) Pub. Date: Aug. 4, 2011

(54) COMMUNICATION APPARATUS AND COMMUNICATION METHOD

(75) Inventors: Jihyung Kim, Daejeon (KR); Dong Hyn Ahn, Daejeon (KR); Kwang Jae Lim, Daejeon (KR); DongSeung Kwon, Daejeon (KR)

(73) Assignee: Electronics and Telecommunications Research Institute, Daejeon (KR)

(21) Appl. No.: 13/020,431

(22) Filed: Feb. 3, 2011

(30) Foreign Application Priority Data
Feb. 4, 2010 (KR) 10-2010-0010593
Feb. 1, 2011 (KR) 10-2011-0009886

(51) Int. Cl. H04W 56/00

(52) U.S. Cl. 370/328

(57) ABSTRACT

A communication apparatus which can operate as a cluster header and a node is disclosed. The cluster header transmits a cluster header preamble signal in a first time interval of the frame, and transmits a cluster control signal in a second time interval of the frame. The cluster header receives a node ranging signal in a third time interval of the frame, receives a node preamble in a fourth time interval of the frame, and receives a node control signal in a fifth time interval of the frame. The cluster header can determine the operation mode of a reported node.

### CROSS-REFERENCE TO RELATED APPLICATION

This application claims priority to and the benefit of Korean Patent Application No. 10-2010-0010593 filed in the Korean Intellectual Property Office on Feb. 4, 2010, and 10-2011-0009886 filed in the Korean Intellectual Property Office on Feb. 1, 2011, the entire contents of which are incorporated herein by reference.

### BACKGROUND OF THE INVENTION

(a) Field of the Invention

The present invention relates to communication apparatus and communication method. Particularly the present invention relates to the frame structure, the node, and operating method of the node in the OFDMA (Orthogonal frequency-division multiple access) Ad-hoc or Mesh network.

(b) Description of the Related Art

The cyclic prefix corresponding to a guard interval is used to meet the time synchronization with consideration for a time delay according to distance between nodes in the present researched OFDMA ad-hoc or mesh network. In a case of using the guard interval, the delay according to a multipath of a channel and the time delay according to distance between nodes need to be included in the guard interval. Therefore, since inefficiency of overhead according to the guard interval increases when distance between nodes is not close, the ranging method for establishing the time synchronization is needed while keeping length of the efficient guard interval. Also, because it is difficult to satisfy synchronization between all nodes through ranging, the resource allocation method for reducing multiple access interference (MAI) is needed

In the other hand, cluster headers can be used in the prior OFDMA ad-hoc or mesh network. In this case, arbitrary nodes can become cluster headers. However, a cluster header is connected to a node through one-hop in a topology. In this case, the number of nodes belonging to both cluster headers increases. Because of this, different clusters can depend on one specific cluster header, and then efficiency according to the cluster header′ functions such as the resource distribution can be deteriorated. Therefore, a method for establishing a cluster header supporting two or more hops is needed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide ranging method for establishing the time synchronization while keeping length of the efficient guard interval in the OFDMA ad-hoc or mesh network and resource allocation for reducing MAI. Also, the present invention has been made in an effort to provide frame structure supporting two or more hop when using the cluster header.

An exemplary embodiment of the present invention provides a communication apparatus for performing communication by using a frame, comprising: a transmitter for transmitting a first preamble in a first time interval of the frame; and a receiver for receiving a ranging signal in a second time interval of the frame, receiving a second preamble in a third time interval of the frame, and receiving a first control signal in a fourth time interval of the frame.

The communication apparatus can further comprises an operation mode determining unit for determining an operation mode of the communication apparatus reported through a fifth time interval.

The operation mode can correspond to a node mode or a cluster header mode.

The operation mode determining unit can determine the operation mode of the reported communication apparatus as the cluster header mode when the number of communication apparatuses reporting about the reported communication apparatus is less than a threshold value.

The first control signal can include information on a delay time that a ranging signal transmitted by the reported communication apparatus underwent, and an identifier generated by the reported communication apparatus.

The transmitter can transmit a second control signal in the second time interval of the frame.

An exemplary embodiment of the present invention provides a communication method for a first communication apparatus to perform communication by using a frame, comprising: trying to receive a first preamble signal of a second communication apparatus in a first time interval of the frame; trying to receive a second preamble signal of a third communication apparatus in a second time interval of the frame; when the first communication apparatus cannot receive the first preamble signal, recognizing a location of the third time interval of the frame for ranging by using the second preamble signal; and transmitting a ranging signal in the third time interval.

Transmitting the ranging signal can comprise transmitting the ranging signal in the third time interval so that the third communication apparatus reports information on the first communication apparatus to the second communication apparatus in a fourth time interval of the frame.

Recognizing the location of the third time interval can comprise recognizing a location of a predetermined frame among a plurality of frames forming a frame period by using the second preamble signal; and recognizing the location of the third time interval in the predetermined frame by using the second preamble signal.

The communication method can further comprise when the first communication apparatus can receive the first preamble signal, recognizing a location of a predetermined frame among a plurality of frame forming a frame period by using the first preamble signal and the second preamble signal; and recognizing a location of a third time interval for ranging by using the first preamble signal and the second preamble signal. Transmitting the ranging signal can further comprise transmitting the ranging signal in the third time interval of the rest of frames at least except the predetermined frame among the plurality of frames.

The communication method can further comprise generating a random identifier, and wherein the ranging signal includes the random identifier.

The information on the first communication apparatus can comprise the random identifier and a delay time that the ranging signal underwent.

Another embodiment of the present invention provides a communication method for a first communication apparatus to perform communication by using a frame, comprising: receiving a first preamble signal of a second communication apparatus in a first time interval of the frame; transmitting a second preamble signal in a second time interval of the frame; receiving a ranging signal of a third communication apparatus in a third time interval of the frame; and reporting information on the third communication apparatus in a fourth time interval of the frame to the second communication apparatus.

The communication method can further comprise estimating a delay time that the ranging signal underwent. The information on the third communication apparatus can comprise information on an estimated delay time.

Information on the third communication apparatus can further comprise a random identifier generated by the third communication apparatus.

The communication method can further comprise receiving a control signal of the second communication apparatus in a fifth time interval of the frame.

The communication method can further comprise receiving a data signal of the second communication apparatus in the fifth time interval; and transmitting a data signal of the first communication apparatus in a sixth time interval of the frame.

Another embodiment of the present invention provides a first communication apparatus to perform communication by using a frame, comprising: a receiver for receiving a first preamble signal of a second communication apparatus in a first time interval of the frame, and receiving a ranging signal of a third communication apparatus in a second time interval of the frame; and a transmitter for transmitting a second preamble signal in a third time interval of the frame, and reporting information on the third communication apparatus to the second communication apparatus in a fourth time interval of the frame.

The first communication apparatus can further comprise an estimator for estimating a delay time that the ranging signal underwent. The information on the third communication apparatus can comprise information on an estimated delay time, and a random identifier generated by the third communication apparatus.

The receiver can receive a control signal of the second communication apparatus in a fifth time interval of the frame, and receive a data signal of the second communication apparatus in the fifth time interval.

The transmitter can transmit a data signal of the first communication apparatus in a sixth time interval of the frame.

### BRIEF DESCRIPTION OF THE DRAWINGS

FIG. 1 shows a topology according to an exemplary embodiment of the present invention.

FIG. 2 shows a frame according to an exemplary embodiment of the present invention.

FIG. 3 shows a topology according to another exemplary embodiment of the present invention.

FIG. 4 shows a ranging method according to an exemplary embodiment of the present invention.

FIG. 5 shows a topology according to another exemplary embodiment of the present invention.

FIG. 6 shows a ranging method according to another exemplary embodiment of the present invention.

FIG. 7 shows a topology according to another exemplary embodiment of the present invention.

FIG. 8 shows a topology according to another exemplary embodiment of the present invention.

FIG. 9 shows a block diagram of a communication apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

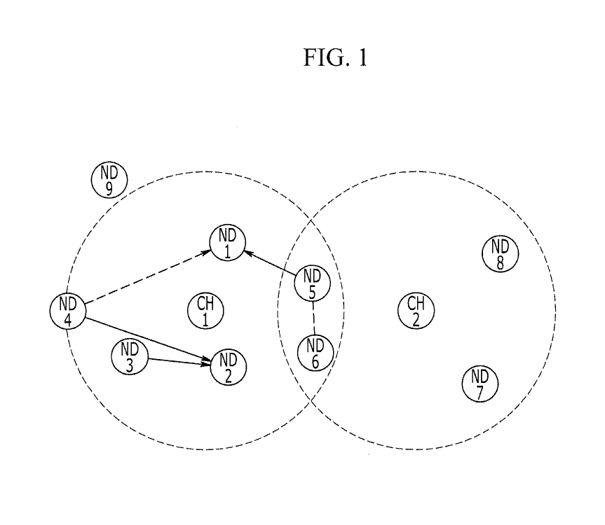

FIG. 1 shows a topology according to an exemplary embodiment of the present invention.

In FIG. 1, the symbol “CH” represents the cluster header and the symbol “ND” represents the node. As shown in FIG. 1, there are two cluster headers CH1 and CH2, and nine nodes ND1 to ND9 according to an exemplary embodiment of the present invention.

The cluster header CH1 basically manages nodes ND1 to ND6 within the radius of the cluster header CH1. Also, the cluster header CH2 manages nodes ND5 to ND8 within the radius of the cluster header CH2.

The node is connected to the cluster header through multi-hop. For example, the node ND9 can be managed by the cluster header CH1 through the node ND1 or the node ND4 on two-hop.

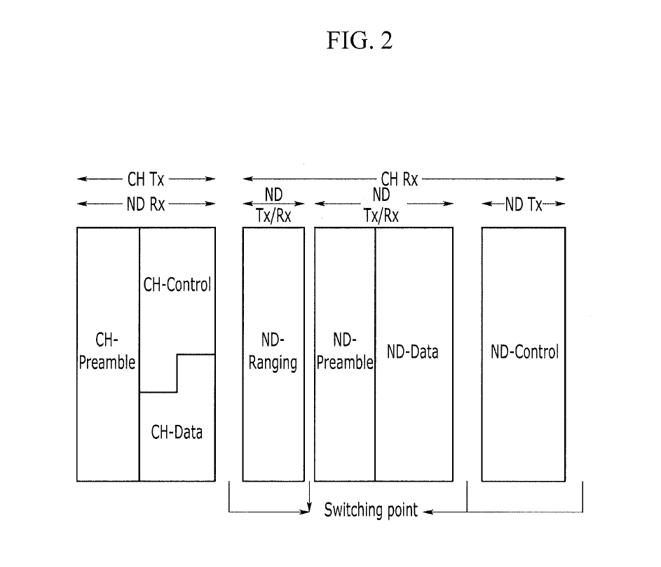

Next, referring to FIG. 2, the frame structure according to an exemplary embodiment of the present invention will be described.

FIG. 2 shows a frame according to an exemplary embodiment of the present invention.

As shown in FIG. 2, a frame according to an exemplary embodiment of the present invention includes a cluster header transmission interval (CH Tx interval) and a cluster header reception interval (CH Rx interval).

The cluster header transmission interval corresponds to the node reception interval (ND Rx interval). The cluster header reception interval includes the first node transmitting/receiving interval (ND Tx/Rx interval), the second node transmitting/receiving interval (ND Tx/Rx interval) and a node transmission interval (ND Tx interval).

The node reception interval includes a cluster header preamble interval, a cluster header control interval and a cluster data interval. The cluster header preamble interval occupies some of time regions of the node reception interval, and the cluster header control interval and cluster data interval occupies the rest of the time regions of the node reception interval.

The first node transmitting/receiving interval corresponds to the node ranging interval (ND-Ranging interval). The second node transmitting/receiving interval includes a node preamble interval and node data interval. The node preamble interval occupies some of time regions of the second node transmitting/receiving interval, and the node data interval occupies the rest of the time regions of the second node transmitting/receiving interval. The node transmission interval corresponds to a node control interval.

A cluster header preamble signal which a cluster header transmits on the cluster header preamble interval plays the role of a basic signal for the time synchronization between nodes within radius of the cluster header, and each cluster header transmits a different form of a signal. The cluster header preamble signal includes different parts of preambles for notifying N_{IR}-th frame. Also, the cluster header preamble is distinguished from the node preamble.

On the cluster header control interval, the cluster header transmits node resource allocation information, information on paths between nodes, information on subframe lengths of CH-Control and CH-data, information on hybrid automatic repeat request (HARQ), information for determining whether the cluster header communicates with a node outside the radius of the cluster header through a relay or changes the outside node into a new cluster header, parameter information for the time synchronization between a transmission node and a reception node, etc.

The cluster header transmits data such as HARQ data of the cluster header in relation to the node on cluster data interval.

On the cluster header preamble interval, the cluster header control interval and the cluster header data interval, the cluster header performs transmission; nodes except the cluster header perform reception.

In a case that the node searches a cluster header preamble signal on the first frame to the (N_{IR}−1)-th frame in a period of N_{IR} frames, namely in a case that the node is within the radius of the cluster header, the node transmits a node ranging signal together with a random identifier (ID) for network entry on the node ranging interval. The cluster header and the node which has already accessed to the cluster header listen to the node ranging signal in a reception mode. After the node listens to the node ranging signal, the node transmits, to the cluster header on the node control interval, a received identifier and distance delay time that the node ranging signal underwent.

If the node does not search the cluster header preamble but the node preamble in a period of N_{IR} frames, the node transmits a node ranging signal together with a random identifier (ID) for network entry on the node ranging interval. The node which has already accessed to the cluster header listens to the node ranging signal in a reception mode, and transmits, to the cluster header on the node control interval, a received identifier and distance delay time that the node ranging signal underwent.

A node preamble signal that the node transmits on the node preamble interval is used for expansion of the radius of the cluster header and the time synchronization of the relay node. N_{NPR} types of node preambles are used such as a basic preamble, a preamble for notifying N₁R-th frame, a preamble for notifying that information is moved between the cluster headers. The node preamble is formed so that a cluster identifier can be recognized.

The node transmits data on the node data interval.

The node transmits control information such as ACK/NACK, a node identifier, and distance delay time to the cluster header on the node control interval.

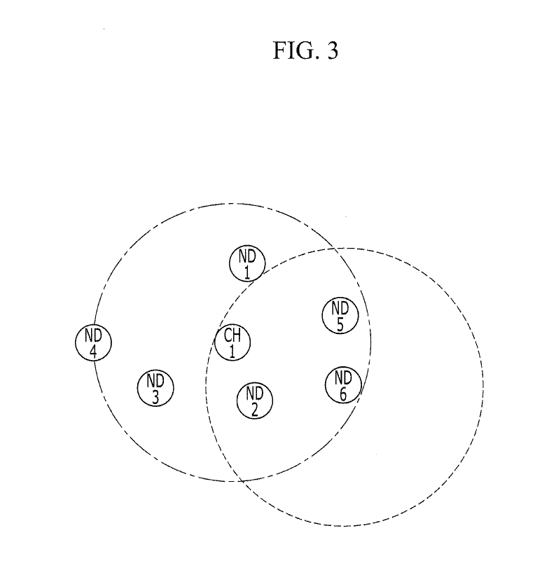

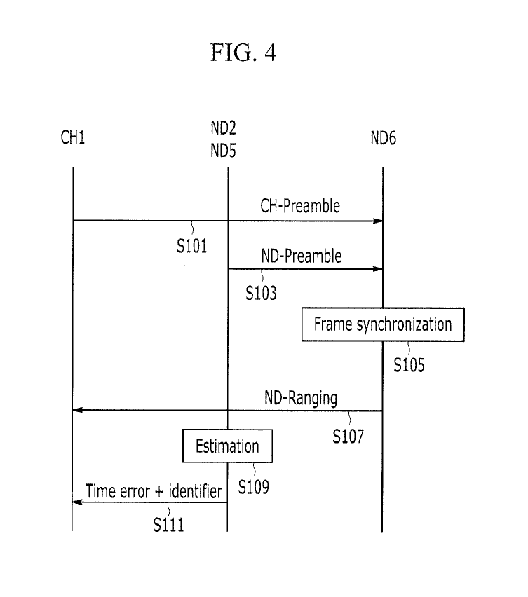

Next, referring to FIG. 3 and FIG. 4, a case that a node trying to newly access to the network can receive the cluster header preamble signal according to an exemplary embodiment of the present invention will be described.

FIG. 3 shows a topology according to another exemplary embodiment of the present invention.

In FIG. 3, assume that a cluster header CH1 manages nodes ND1 to ND5, and a node ND6 tries to turn on the power.

FIG. 4 shows a ranging method according to an exemplary embodiment of the present invention.

The node ND6 searches a cluster header preamble of the cluster header CH1 and a node preamble in steps S101 and S103.

The node ND6 checks a cluster identifier belonging to the node ND6 and the location of N_{IR}-th frame through the cluster header preamble signal, checks the location of N_{IR}-th frame through the node preamble, and checks the location of the node ranging interval through the cluster header preamble and the node preamble in step S105.

The node ND6 generates a random identifier in the node ranging interval of the first to (N_{IR}−1)-th frames, and generates a node ranging signal together with the generated identifier and cluster identifier in step S107.

The node ND5, the node ND2 and the cluster header CH1 that are within the radius of the node ND6 receive a ranging signal of the node ND6, and estimate time error (or timing offset) according to distance delay and the identifier of the ranging signal in step S109.

The node ND5 and the node ND2 transmits the estimated time error and the estimated identifier to the cluster header CH1 on the node control interval in step S111.

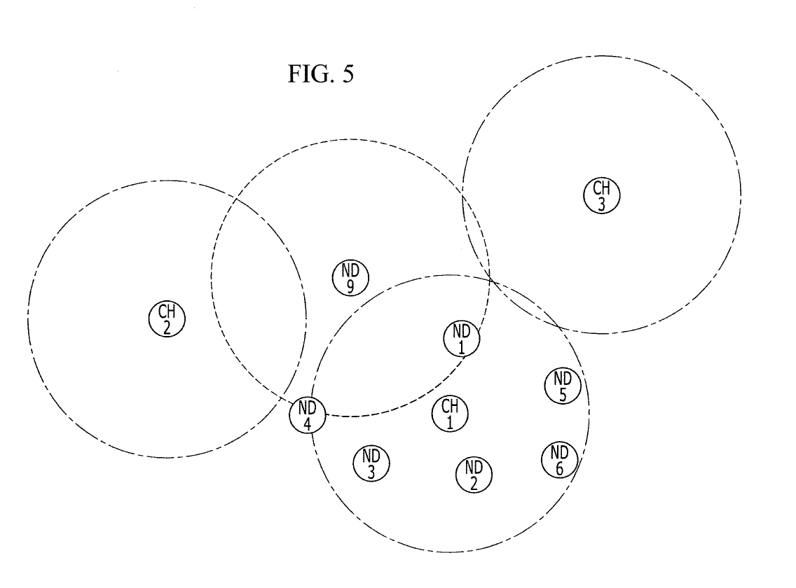

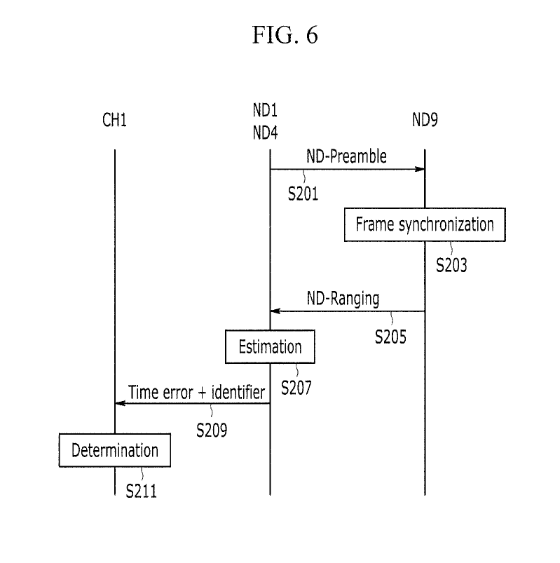

Next, referring to FIG. 5 and FIG. 6, a case that a node trying to newly access to the network cannot receive the cluster header preamble signal according to an exemplary embodiment of the present invention will be described.

FIG. 5 shows a topology according to another exemplary embodiment of the present invention. In FIG. 5, assume that a cluster header CH1 manages nodes ND1 to ND6, and a node ND9 tries to turn on the power.

FIG. 6 shows a ranging method according to another exemplary embodiment of the present invention.

The node ND9 searches a cluster header preamble and a node preamble in step S201.

If the node ND9 cannot receive the cluster header preamble signal, the node ND9 checks the location of the N_{IR}-th frame and the location of the node ranging interval through the node preamble signal in step S203.

The node ND9 generates a random identifier in the node ranging interval of the N_{IR}-th frame, and generate a node ranging signal together with the generated identifier in step S205.

The node ND1 and the node ND4 that are within the radius of the node ND9 receive the node ranging signal of the node ND9, and estimate time error (or timing offset) according to distance delay and a identifier of the ranging signal in step S207.

The node ND1 and the node ND4 transmits the estimated time error and the estimated identifier to the cluster header CH1 on the node control interval in step S209.

Through information of the node control interval, the cluster header CH1 determines whether the node ND9 becomes a new cluster header or a node depending on the cluster header CH1 in step S211. There can be various methods for determining whether the node ND9 becomes a new cluster header or belongs to a different cluster header. For example, if the number of nodes which report about the node ND9 among nodes managed by the cluster header CH1 is greater than a threshold value, the cluster header CH1 can determine the node ND9 as a node depending on the cluster header CH1; otherwise the cluster header CH1 can determine the node ND9 as a new cluster header.

As described above, the ranging signal is used for measuring the time synchronization error according to a mutual distance delay between nodes. In particular, node ranging intervals of frames except the N_{PR}-th frame and the N_{CR}-th frame among the first to (N_{IR}−1)-th frames are used for initial ranging of nodes receiving the cluster header preamble signal. The node ranging interval of the N_{IR}-th frame except the N_{PR}-th frame and the N_{CR}-th frame is used for initial ranging of nodes receiving the node preamble signal. The node ranging interval of the N_{PR}-th frame is used for periodic ranging. The node ranging interval of the N_{CR}-th frame is used for initial ranging for transmitting/receiving node information to/from adjacent clusters.

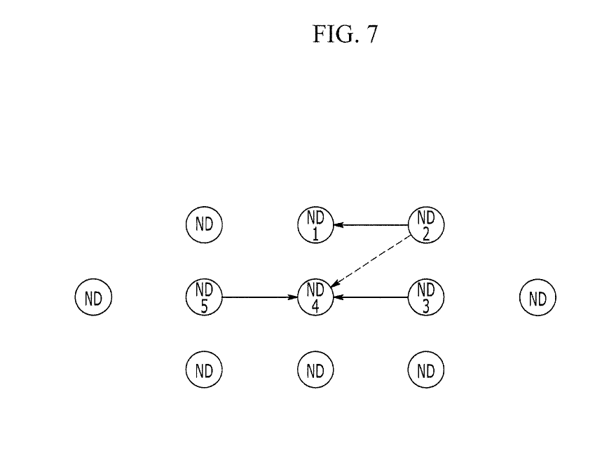

Next, referring to FIG. 7, scheduling and resource allocation of the cluster header according to an exemplary embodiment of the present invention will be described.

FIG. 7 shows a topology according to another exemplary embodiment of the present invention.

In FIG. 7, when a node ND2 transmits a signal to node ND1 through the sc₂-th subcarrier group channel, a node ND5 and a node ND3 transmit a signal to a node ND4 through the sc₅-th subcarrier group channel and the sc₃-th subcarrier group channel, respectively.

The cluster header makes a table of time synchronization errors that the adjacent nodes transmit on the node control interval. Also, on the node control interval, each node can send to the cluster header channel quality information (CQI) between nodes which is estimated through the cluster header preamble, the node preamble, etc. Because the cluster header can recognize information such as each node's identifier, the cluster header establishes the optimal routing path to transmit to the node on cluster header control interval. When the cluster header establishes the optimal routing path, the cluster header can use CQI.

In the other hand, when transmission between nodes is established, an effect of time synchronization error can be considered. Methods for considering the time synchronization error are various.

For the first example of considering the time synchronization error, when the node ND3 transmits a signal to the node ND4, the cluster header transmits the time synchronization error on the cluster header control interval to the node ND3 so that the node ND3 can transmits the signal to the node ND4 in consideration of the time synchronization error. The same method can be applied to cases of the node ND5 and node ND2.

For the second example of considering the time synchronization error, if time synchronization error of the node ND5 is within the cyclic prefix (CP) interval of the node ND4 and the node ND3 generates time synchronization error with the node ND4, the cluster header notifies the time synchronization error of the node ND3 to the node ND4 so that the node ND4 as a receiver can reduce influence resulting from the time synchronization error.

For the third example of considering the time synchronization error, when the node ND2 transmits a signal to the node ND1 in consideration of the time synchronization error, the node ND4 undergoes the influence resulting from the time synchronization error. In this case, through a similar method to the second example, the node ND4 can reduce the influence resulting from the time synchronization error the node ND2.

For the fourth example of considering the time synchronization error, by keeping the transmission channel sc₂ of the node ND2 away from the transmission channels sc₃ and sc₅ of the node ND3 and the node ND5 in frequency domain, it is possible to reduce the influence of inter-subcarrier interference (ICI) resulting from the time synchronization error.

These examples can be used by combining appropriately. Also, these examples of considering the time synchronization can be applied to scheduling and resource allocation for establishing paths.

The performance reduction resulting from performing simultaneously point-to-multipoint (PMP) communication and multipoint-to-point (MPP) communication for nodes in a case that the time synchronization error occurs can be considered in scheduling and resource allocation of the cluster header

For example, in a case that the node ND2 performs PMP transmission to the node ND1 and the node ND4 and the node ND4 performs MPP reception from the node ND2, the node ND3, and the node ND5, each time synchronization error can be generated. Therefore, algorithm with consideration for this can be developed.

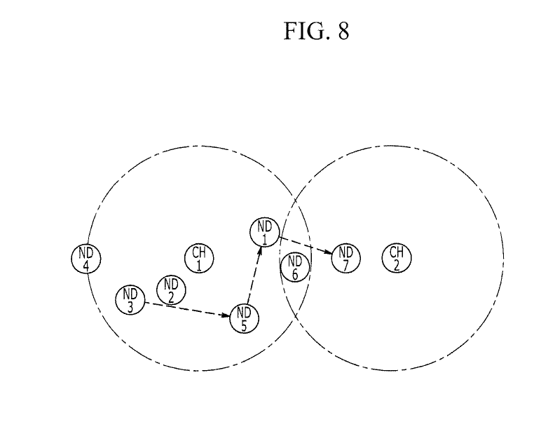

Next, referring to FIG. 8, a path movement between clusters according to an exemplary embodiment of the present invention will be described.

FIG. 8 shows a topology according to another exemplary embodiment of the present invention.

Basically the cluster headers are initially established so that their radiuses are not overlapped. Therefore, the cluster header CH1 and cluster header CH2 use the node in order to recognize information of the other party.

In a case that the node ND6 exists and the node ND6 is initially accessed to the cluster header CH1, the node ND6 recognizes the cluster header CH2 through the cluster header preamble interval, notifies information of the cluster header CH2 on the node control interval to the cluster header CH1, and notifies information of the cluster header CH1 to the cluster header CH2 through a ranging signal of the N_{CR}-th frame. Through this, the cluster header CH1 and cluster header CH2 can request and receive routing path information of each node through the node ND6.

Even if the node ND6 does not exist, the node ND1 and node ND7 can recognize existence of the other party through the node preamble, and request and receive information of each cluster header through the ranging signal of the N_{CR}-th frame.

Next, the node mobility and the disconnection with the cluster header will be described.

In a case that there is no global positioning system (GPS) between clusters, the independent frame standard time can be established with the cluster header as a center. For a case that the radiuses of the clusters are overlapped due to the cluster movement, the standard time identification can be developed.

For the cluster header's absence resulting from various reasons such as the disconnection with the cluster header, an arbitrary node can be set as a sub-cluster header.

Next, the persistent allocation according to an exemplary embodiment of the present invention will be described.

In a case that a cluster header suddenly disappears, communication between nodes can be cut off under the influence of the cluster header. Therefore, for communication between nodes requiring the persistent allocation, it is necessary to minimize control of the cluster header.

For this, after the cluster header once allocates the channel to nodes which perform persistent communication, the cluster header re-allocates the channel in a long-term period.

The nodes which perform persistent communication change the channel according to the periodic commands of the cluster header, and then, if the commands cannot be received due to disappearance of the cluster header, the nodes continue to use the final channel.

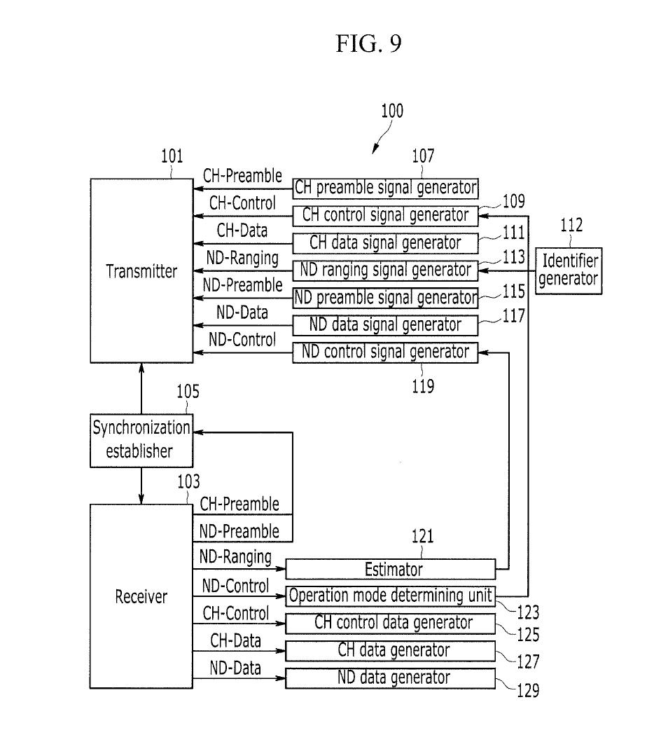

Next, referring to FIG. 9, a communication apparatus according to an exemplary embodiment of the present invention will be described.

FIG. 9 shows a block diagram of a communication apparatus according to an exemplary embodiment of the present invention.

The communication apparatus 100 according to an exemplary embodiment of the present invention can operate as a node or a cluster header. In particular, in a case that the communication apparatus 100 operates only as a node or only as a cluster header, unnecessary constituent elements can be eliminated.

As shown in FIG. 9, the communication apparatus 100 according to an exemplary embodiment of the present invention includes a transmitter 101, a receiver 103, a synchronization establisher 105, a CH preamble signal generator 107, a CH control signal generator 109, a CH data signal generator 111, an identifier generator 112, an ND ranging signal generator 113, an ND preamble signal generator 115, an ND data signal generator 117, an ND control signal generator 119, an estimator 121, an operation mode determining unit 123, a CH control data generator 124, a CH data generator 125, and an ND data generator 127.

In a case that the communication apparatus 100 operates as the cluster header, transmitter 101 transmits a cluster header preamble signal, a cluster header control signal, and a cluster header data signal on the frame structure as shown in FIG. 2. And the receiver 103 receives a node ranging signal, a node preamble signal, a node data signal, and a node control signal on the frame structure as shown in FIG. 2.

In a case that the communication apparatus 100 does not operate as the cluster header but as the node, transmitter 101 transmits a node ranging signal, a node preamble signal, a node data signal, and a node control signal on the frame structure as shown in FIG. 2. And receiver 103 receives a cluster header preamble signal, a cluster header control signal, a cluster header data signal, a node ranging signal, a node preamble signal, and a node data signal on the frame structure as shown in FIG. 2.

The synchronization establisher 105 recognizes the location of the N_{IR}-th frame, the location of the cluster header control interval, the location of the cluster header data interval, the location of the node ranging interval, the location of the node data interval, the location of the node control interval, etc. through one or all of the cluster header preamble and the node preamble.

The CH preamble signal generator 107 generates a cluster header preamble signal.

The CH control signal generator 109 generates a cluster header control signal including node resource allocation information, information on paths between nodes, information on subframe lengths of CH-Control and CH-data, information on hybrid automatic repeat request (HARQ), information for determining whether the cluster header communicates with a node outside the radius of the cluster header through a relay or changes the outside node into a new cluster header, parameter information for the time synchronization between a transmission node and a reception node, etc.

The CH data signal generator 111 generates a cluster header data signal.

The identifier generator 112 generates an identifier for the initial network entry.

The ND ranging signal generator 113 generates a node ranging signal including the identifier generated by the identifier generator 112.

The ND preamble signal generator 115 generates a node preamble signal.

The ND data signal generator 117 generates a node data signal.

The ND control signal generator 119 generates a node control signal including the distance delay time and the identifier which are estimated by the estimator 121.

The estimator 121 estimates the distance delay time and the identifier through the node ranging signal.

The operation mode determining unit 123 determines the reported node as a new cluster header or a node depending on the cluster header through information of the node control signal.

The CH control data generator 124 extracts cluster header control data from the received cluster header control signal.

The CH data generator 125 generates cluster header data from the received cluster header data signal.

The ND data generator 127 generates node data from the received node data signal.

According to aspects of the present invention, it is possible to establish the time synchronization while keeping length of the efficient guard interval and reduce MAI. Also, the node can access to the cluster header through two-hop or more, independence of the cluster can be improved, and the link distance between nodes can be expanded.

The exemplary embodiments of the present invention are not implemented only by a device and/or method, but can be implemented through a program for realizing functions corresponding to the configuration of the exemplary embodiments of the present invention and a recording medium having the program recorded thereon. These implementations can be realized by the ordinarily skilled person in the art from the description of the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A communication apparatus for performing communication by using a frame, comprising:
a transmitter for transmitting a first preamble in a first time interval of the frame; and
a receiver for receiving a ranging signal in a second time interval of the frame, receiving a second preamble in a third time interval of the frame, and receiving a first control signal in a fourth time interval of the frame.

2. The communication apparatus of claim 1, further comprising:
an operation mode determining unit for determining an operation mode of the communication apparatus reported through a fifth time interval.

3. The communication apparatus of claim 2, wherein the operation mode corresponds to a node mode or a cluster header mode.

4. The communication apparatus of claim 3, wherein the operation mode determining unit determines the operation mode of the reported communication apparatus as the cluster header mode when the number of communication apparatuses reporting about the reported communication apparatus is less than a threshold value.

5. The communication apparatus of claim 2, wherein the first control signal includes information on a delay time that a ranging signal transmitted by the reported communication apparatus underwent, and an identifier generated by the reported communication apparatus.

6. The communication apparatus of claim 5, wherein the transmitter transmits a second control signal in the second time interval of the frame.

7. A communication method for a first communication apparatus to perform communication by using a frame, comprising:
trying to receive a first preamble signal of a second communication apparatus in a first time interval of the frame;
trying to receive a second preamble signal of a third communication apparatus in a second time interval of the frame;
when the first communication apparatus cannot receive the first preamble signal, recognizing a location of the third time interval of the frame for ranging by using the second preamble signal; and
transmitting a ranging signal in the third time interval.

8. The communication method of claim 7, wherein transmitting the ranging signal comprises:
transmitting the ranging signal in the third time interval so that the third communication apparatus reports information on the first communication apparatus to the second communication apparatus in a fourth time interval of the frame.

9. The communication method of claim 8, wherein recognizing the location of the third time interval comprises:
recognizing a location of a predetermined frame among a plurality of frames forming a frame period by using the second preamble signal; and
recognizing the location of the third time interval in the predetermined frame by using the second preamble signal.

10. The communication method of claim 8, further comprising:
when the first communication apparatus can receive the first preamble signal, recognizing a location of a predetermined frame among a plurality of frame forming a frame period by using the first preamble signal and the second preamble signal; and
recognizing a location of a third time interval for ranging by using the first preamble signal and the second preamble signal, and
wherein transmitting the ranging signal further comprises:
transmitting the ranging signal in the third time interval of the rest of frames at least except the predetermined frame among the plurality of frames.

11. The communication method of claim 10, further comprising:
generating a random identifier, and
wherein the ranging signal includes the random identifier.

12. The communication method of claim 11, wherein the information on the first communication apparatus comprises the random identifier and a delay time that the ranging signal underwent.

13. A communication method for a first communication apparatus to perform communication by using a frame, comprising:
receiving a first preamble signal of a second communication apparatus in a first time interval of the frame;
transmitting a second preamble signal in a second time interval of the frame;
receiving a ranging signal of a third communication apparatus in a third time interval of the frame; and
reporting information on the third communication apparatus in a fourth time interval of the frame to the second communication apparatus.

14. The communication method of claim 13, further comprising:
estimating a delay time that the ranging signal underwent, and
wherein the information on the third communication apparatus comprises information on an estimated delay time.

15. The communication method of claim 14, wherein information on the third communication apparatus further comprises a random identifier generated by the third communication apparatus.

16. The communication method of claim 15, further comprising:
receiving a control signal of the second communication apparatus in a fifth time interval of the frame.

17. The communication method of claim 16, further comprising:
receiving a data signal of the second communication apparatus in the fifth time interval; and
transmitting a data signal of the first communication apparatus in a sixth time interval of the frame.

18. A first communication apparatus to perform communication by using a frame, comprising:
a receiver for receiving a first preamble signal of a second communication apparatus in a first time interval of the frame, and receiving a ranging signal of a third communication apparatus in a second time interval of the frame; and
a transmitter for transmitting a second preamble signal in a third time interval of the frame, and reporting information on the third communication apparatus to the second communication apparatus in a fourth time interval of the frame.

19. The first communication apparatus of claim 18, further comprising:
an estimator for estimating a delay time that the ranging signal underwent, and
wherein the information on the third communication apparatus comprises information on an estimated delay time, and a random identifier generated by the third communication apparatus.

20. The first communication apparatus of claim 19, wherein the receiver receives a control signal of the second communication apparatus in a fifth time interval of the frame, and receives a data signal of the second communication apparatus in the fifth time interval, and
the transmitter transmits a data signal of the first communication apparatus in a sixth time interval of the frame.
